(19) United States
(12) Patent Application Publication
(10) Pub. No.: US 2019/0230115 A1
(43) Pub. Date: Jul. 25, 2019

(54) FATIGUE-BASED SEGMENT ROUTING

(71) Applicant: Cisco Technology, Inc., San Jose, CA (US)

(72) Inventors: Robert Edgar Barton, Richmond (CA); Jerome Henry, Pittsboro, NC (US)

(21) Appl. No.: 15/877,666

(22) Filed: Jan. 23, 2018

(51) Int. Cl. H04L 29/06; H04L 12/707

(52) U.S. Cl. CPC H04L 63/1458; H04L 45/44; H04L 63/1425; H04L 45/22

(57) ABSTRACT

In one example, a path computation element of a network configured for segment routing receives, from a plurality of path computation clients in the network, segment identifiers identifying a destination segment. A particular type of network traffic is destined for the destination segment. Based on the segment identifiers identifying the destination segment, the path computation element determines that the destination segment is a destination for the particular type of network traffic. The path computation element receives, from the plurality of path computation clients, information indicating fatigue states for segments of the network. The fatigue states are associated with the particular type of network traffic. If the fatigue states satisfy one or more conditions, the path computation element instructs the plurality of path computation clients to route the particular type of network traffic so as to proactively mitigate one or more fatigue-affected segments in the network.

### TECHNICAL FIELD

The present disclosure relates to computer networking.

### BACKGROUND

Distributed Denials of Service (DDoS) attacks can unequally affect different parts of a network. DDoS attacks primarily target critical nodes (e.g., web or Domain Name System (DNS) servers) that are exposed to the Internet. Recently, DDoS attacks have begun affecting enterprise and service provider networking equipment and links (e.g., ransomware through outgoing link saturation).

### BRIEF DESCRIPTION OF THE DRAWINGS

FIG. 1 is a block diagram of a network configured to execute fatigue-based segment routing techniques, according to an example embodiment.

FIG. 2 is a flowchart illustrating a high-level method for carrying out techniques described in accordance with FIG. 1, according to an example embodiment.

FIG. 3 is a block diagram of the network of FIG. 1 at a later point in time, according to an example embodiment.

FIG. 4 is a flowchart illustrating a high-level method for carrying out techniques described in accordance with FIG. 3, according to an example embodiment.

FIG. 5 is a block diagram of a path computation element configured to execute fatigue-based segment routing, according to an example embodiment.

FIG. 6 is a flowchart of a method for fatigue-based segment routing, in accordance with examples presented herein.

### DESCRIPTION OF EXAMPLE EMBODIMENTS

### Overview

In one embodiment, a path computation element of a network configured for segment routing receives, from a plurality of path computation clients in the network, segment identifiers identifying a destination segment. A particular type of network traffic is destined for the destination segment. Based on the segment identifiers identifying the destination segment, the path computation element determines that the destination segment is a destination for the particular type of network traffic. The path computation element receives, from the plurality of path computation clients, information indicating fatigue states for segments of the network. The fatigue states are associated with the particular type of network traffic. If the fatigue states satisfy one or more conditions, the path computation element instructs the plurality of path computation clients to route the particular type of network traffic so as to proactively mitigate one or more fatigue-affected segments in the network.

### Example Embodiments

Traditional DDoS mitigation techniques are reactive to a DDoS attack. That is, conventionally, a system will only recognize a DDoS attack after the attack is in full force. Such an ongoing DDoS attack is typically combatted by, for example, relying on in-band traffic scrubbers or by black-holing suspicious traffic. By contrast, techniques are presented herein to proactively detect a DDoS attack and take action based on certain early warning signs of such an attack. As described in greater detail below, these techniques may involve analyzing weakening points in a network based on fatigue levels between routing nodes in the network.

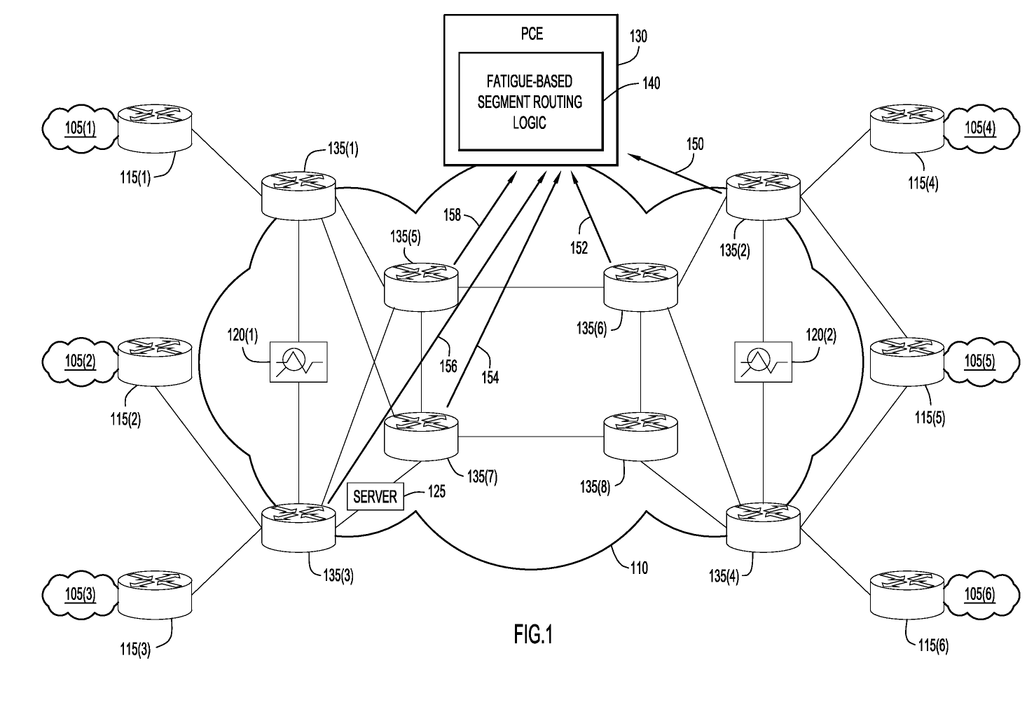

With reference made to FIG. 1, shown is a block diagram of a network configured to execute fatigue-based segment routing techniques in accordance with examples presented herein. FIG. 1 illustrates networks 105(1)-105(6), each of which are in communication with network 110 configured for segment routing. Networks 105(1)-105(6) respectively include network elements 115(1)-115(6) (e.g., routers, switches, etc.) to enable communication with network 110. Network 110 includes scrubbers 120(1) and 120(2). Network 110 may serve as a backbone transit network for web server 125 and, in one example, web server 125 is outside network 110. Or, as shown in FIG. 1, web server 125 is inside network 110. Network 110 further includes path computation element 130 and path computation clients 135(1)-135(8). Path computation clients 135(1)-135(8) may be any suitable network element, such as routers, switches, firewalls, etc.

Path computation clients 135(1)-135(4) may be referred to herein as “redistribution network elements,” such as redistribution routers. A redistribution network element may be a network element that (1) serves as a common connection point for a collection of other network elements and/or (2) enables a redistribution of protocols, which may signal that the redistribution network element is located between two domains. An example of a redistribution network element that performs function (1) is a gateway between an enterprise network and the Internet. An example of a redistribution network element that performs function (2) is a protocol converter between the Enhanced Interior Gateway Routing Protocol (EIGRP) and the Open Shortest Path First (OSPF) protocol. A redistribution network element may be located between two networks, collections/groupings of network elements within a network, routing domains, and/or autonomous systems.

In the example of FIG. 1, path computation client 135(1) is a redistribution network element for network 105(1); path computation client 135(2) is a redistribution network element for networks 105(4) and 105(5); path computation client 135(3) is a redistribution network element for networks 105(2) and 105(3); and path computation client 135(4) is a redistribution network element for networks 105(5) and 105(6). However, in general, the techniques presented herein may or may not involve redistribution network elements (e.g., in another example, path computation clients 135(1)-135(4) may be generic routers/switches/etc.).

Path computation element 130 executes fatigue-based segment routing logic 140 to enable proactive mitigation of DDoS attacks. In segment routing, a network segment may be either a link (“adjacent segment”) or a node (“nodal segment”). Both types of segment may be susceptible to DDoS attacks, and as such may have associated fatigue levels in accordance with the techniques presented herein. The path computation element 130 may send, to path computation clients 135(1)-135(8), segment identifiers identifying a particular type of network traffic. The particular type of network traffic may be network traffic that is potentially associated with a DDoS attack.

These segment identifiers may indicate a destination port of the particular type of network traffic that is susceptible to DDoS attacks. For example, traffic destined for User Datagram Protocol (UDP) port 53 (reserved for Domain Name System (DNS) communications) may indicate a DNS overflow type DDoS attack; traffic destined for Transmission Control Protocol (TCP) port 80 (reserved for Hypertext Transfer Protocol (HTTP) communications) may indicate a web overload type DDoS attack; etc. The path computation element 130 may send the segment identifiers using any path computation communication protocol, such as Path Computation Element Communication Protocol (PCEP).

The path computation element 130 may determine which particular type of network traffic is potentially associated with a DDoS attack based on communications received from network traffic pattern detection tools (e.g., Arbor Networks® Peakflow® tool). In one example, one or more such tools may send a list of “hot signatures” (i.e., particular types of network traffic that are potentially associated with a DDoS attack) to the path computation element 130. Based on this list of hot signatures, the path computation element 130 may send, to path computation clients 135(1)-135(8), the segment identifiers identifying the particular type(s) of network traffic.

Each of path computation clients 135(1)-135(8) may observe network traffic that is in transit in order to identify whether any of the transiting network traffic is the particular type of network traffic, that is, traffic susceptible to a DDoS attack. The path computation clients 135(1)-135(8) may, for example, compare the destination port of the transiting network traffic to the destination port identified in the segment identifiers identifying the particular type of network traffic.

If one or more of the path computation clients 135(1)-135(8) observe a match (i.e., if the transiting network traffic is of the particular type identified in the segment identifiers), those path computation clients may send, to the path computation element 130, segment identifiers identifying a destination segment. The destination segment may be the segment (and/or port) to which the particular type of network traffic is destined. Based on the segment identifiers identifying the destination segment, the path computation element 130 may determine that the destination segment is a destination for the particular type of network traffic.

In one example, the destination port of the particular type of traffic is UDP port 53 (i.e., the particular type of traffic is DNS traffic), and is destined for web server 125 (i.e., the destination segment). As represented by the arrows 150, 152, 154, 156 and 158 in FIG. 1, path computation clients 135(2), 135(3), 135(5), 135(6), and 135(7) may each send to the path computation element 130 segment identifiers indicating that one or more segments near web server 125 are fatigue-prone. The path computation clients 135(2), 135(3), 135(5), 135(6), and 135(7) may determine that paths toward (e.g., segments near) the web server 125 are fatigue-prone by observing that the IP address of the web server 125 (e.g., 10.10.10.0) is the destination Internet Protocol (IP) address associated with the particular type of network traffic. Upon receiving the segment identifiers from path computation clients 135(2), 135(3), 135(5), 135(6), and 135(7), path computation element 130 may determine that web server 125 is a destination for the particular type of network traffic.

As mentioned above, path computation clients 135(2) and 135(3) are redistribution network elements, and may therefore be fatigue prone. Other examples of fatigue prone network elements include oversubscribed aggregation points, transit links to other providers, etc. In one example, path computation client 135(2) serves as an entry point to network 110 for networks 105(4) and 105(5), and is therefore susceptible to DDoS attacks originating from networks 105(4) and 105(5). As such, the segment identifier received from path computation client 135(2) may indicate that path computation client 135(2) is a redistribution network element. This indication may be in the form of a “redistribution” tag/flag in the packet of the segment identifier.

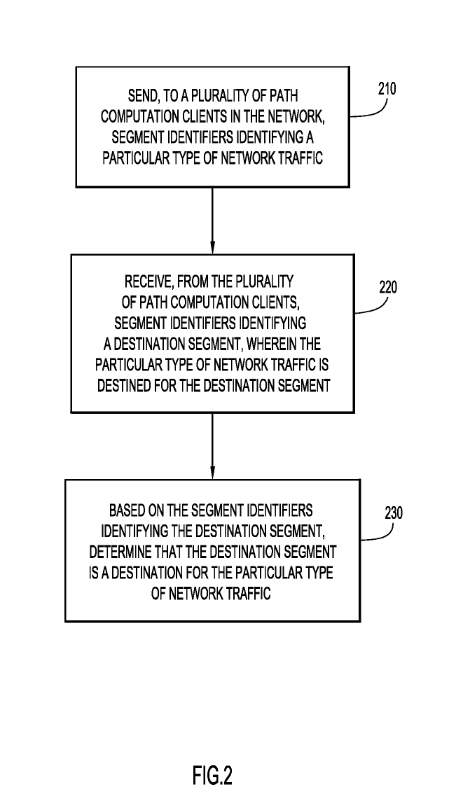

Reference is now made to FIG. 2. FIG. 2 is a flowchart illustrating, at a high-level, a method for carrying out techniques described above in accordance with FIG. 1. The method may be performed by a path computation element of a network configured for segment routing, such as path computation element 130. At 210, the path computation element sends, to a plurality of path computation clients in the network, segment identifiers identifying a particular type of network traffic. At 220, the path computation element receives, from a plurality of path computation clients in the network, segment identifiers identifying a destination segment, wherein the particular type of network traffic is destined for the destination segment. At 230, based on the segment identifiers identifying the destination segment, the path computation element determines that the destination segment is a destination for the particular type of network traffic.

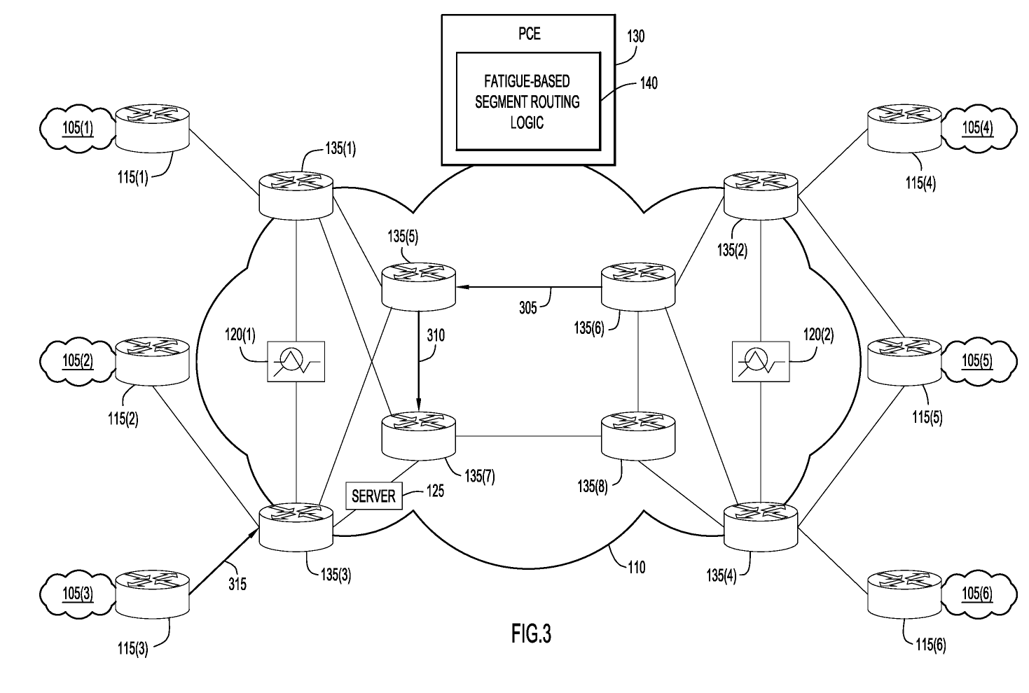

With reference now to FIG. 3, a diagram of the network of FIG. 1 is shown, but at a later point in time, in accordance with examples presented herein. Arrow 305 represents the particular type of network traffic that is flowing from path computation client 135(6) to path computation client 135(5). Arrow 310 represents the particular type of network traffic that is flowing from path computation client 135(5) to path computation client 135(7). Arrow 315 represents the particular type of network traffic that is flowing from network element 115(3) to path computation client 135(3).

In one example, network traffic 305 is associated with a fatigue index of 30 for the segment from path computation client 135(6) to path computation client 135(5). This means that the particular type of traffic destined for UDP port 53 of web server 125 accounts for 30% of the bandwidth of the corresponding segment. Network traffic 310 is associated with a fatigue index of 45 for the segment from path computation client 135(5) to path computation client 135(7). This means that the particular type of traffic destined for UDP port 53 of web server 125 accounts for 45% of the bandwidth of the corresponding segment. Network traffic 315 is associated with a fatigue index of 5 for the segment from network element 115(3) to path computation client 135(3). This means that the particular type of traffic destined for UDP port 53 of web server 125 accounts for 5% of the bandwidth of the corresponding segment.

Path computation clients 135(2), 135(3), 135(5), 135(6), and 135(7) may send, to the path computation element 130, information indicating fatigue levels for these segments/portions/links. The fatigue level may be a dynamically changing measurement that evolves over time as packet loss is observed for links/nodes, and may be continually monitored (e.g., by path computation clients 135(2), 135(3), 135(5), 135(6), and 135(7)). The information indicating fatigue levels may be, for example, a number of network packets of the particular type of network traffic received by the path computation clients 135(2), 135(3), 135(5), 135(6), and 135(7) in a given period of time. This information may also/alternatively be expressed as a portion (e.g., percentage) of bandwidth used by the particular type of network traffic, a change in the number of network packets, a change in the bandwidth, a pre-calculated fatigue metric, raw data, etc.

Thus, the path computation element 130 may receive, from the path computation clients 135(2), 135(3), 135(5), 135(6), and 135(7), information indicating fatigue levels for segments of network 110, where the fatigue levels are associated with the particular type of network traffic. Since the network 110 is configured for segment routing, the path computation element 130 may have a full topological view of the network 110. Using this topological view, the path computation element 130 may generate a network map that includes information regarding the fatigue levels of segments of the network 110 (e.g., the fatigue levels discussed in connection with arrows 305, 310, and 315). The network map may be based on the fatigue levels of segments/points in the network 110 that could potentially be most impacted by/susceptible to a DDoS attack. Thus, in one example, the path computation element 130 may generate a network map of the segments, where the network map includes the fatigue levels.

If the fatigue levels exceed one or more fatigue thresholds, the path computation element 130 may instruct one or more of path computation clients 135(1)-135(8) (such as path computation clients 135(2), 135(3), 135(5), 135(6), and 135(7)) to route the particular type of network traffic so as to proactively mitigate the fatigue levels. The path computation element 130 may instruct path computation clients 135(1)-135(8) to route the particular type of network traffic based on the network map generated by the path computation element 130. In one example, the path computation element 130 instructs path computation clients 135(2), 135(3), 135(5), 135(6), and 135(7) to route the particular type of network traffic so as to proactively defend against a DDoS attack.

The fatigue threshold(s) may be a fatigue index, and may be static (such as set by a network administrator) or learned dynamically, such as via machine learning. The fatigue threshold(s) may be, for example, a number of network packets of the particular type of network traffic received by the path computation clients 135(2), 135(3), 135(5), 135(6), and 135(7) in a given period of time. The fatigue threshold(s) may also/alternatively be expressed as a portion (percentage) of bandwidth used by the particular type of network traffic, a change in the number of network packets, a change in the bandwidth, a pre-calculated fatigue metric, raw data, etc.

The path computation element 130 and/or the path computation clients 135(1)-135(8) may determine whether the fatigue levels exceed the one or more fatigue thresholds. In a first example, the path computation element 130 may determine whether the fatigue levels exceed the one or more fatigue thresholds before instructing one or more of path computation clients 135(1)-135(8) to route the particular type of network traffic so as to proactively mitigate the fatigue levels. For instance, path computation element 130 may determine that a link is a 10 G link and, based on that information as well as the fatigue level information received from one or more of path computation clients 135(1)-135(8), may determine that the fatigue level on that link is reaching a threshold at which network packets may be dropped.

In a second example, the path computation clients 135(1)-135(8) may determine whether the fatigue levels exceed the one or more fatigue thresholds. In this second example, the path computation element 130 may receive, from the path computation clients 135(2), 135(3), 135(5), 135(6), and 135(7), information indicating whether the fatigue levels exceed the one or more fatigue thresholds. For example, the path computation clients 135(1)-135(8) may monitor the particular type of network traffic and, when the particular type of network traffic exceeds a fatigue threshold, the path computation clients 135(1)-135(8) may send the fatigue level to the path computation element 130.

In the example of FIG. 3, the fatigue level associated with the particular type of network traffic 315 (fatigue index 5) does not exceed the corresponding threshold. Thus, path computation element 130 permits all of the particular type of traffic 315 received at path computation client 135(3) from network element 115(3) to proceed to the web server 125.

Meanwhile, the fatigue level associated with network traffic 310 (fatigue index 45) exceeds the corresponding fatigue threshold. As such, path computation element 130 instructs path computation client 135(7) to route all of the network traffic 310 received by path computation client 135(7) from path computation client 135(5) to scrubber 120(1) (such as via path computation client 135(1)) so as to proactively mitigate the fatigue levels. Path computation element 130 may use the fatigue map to make such forwarding decisions (to redirect network traffic 315 to scrubber 120(1)).

The path computation element 130 may make these instructions by, for example, imposing a new segment identifier in the label stack (or rearranging the label stack to re-engineer the traffic path around the high fatigue points) at the path computation client 135(7). The path computation element 130 may send this instruction not only to the (reporting) path computation client 135(7), but also to other path computation clients (such as path computation client 135(1)) on the label path). In addition/alternatively, since path computation client 135(7) knows the path to the target segment (scrubber 120(1)), the fatigue instruction may also be distributed among path computation clients.

The fatigue level associated with network traffic 305 (fatigue index 30) also exceeds the corresponding fatigue threshold (fatigue index 30), but not by as much as network traffic 310 (fatigue index 45). In this example, the path computation element 130 instructs path computation client 135(5) to route only a portion of the particular type of network traffic 305 received by path computation client 135(5) from path computation client 135(6) to scrubber 120(1) (such as via path computation client 135(1)).

The path computation element 130 may further instruct path computation client 135(5) to route the remaining portion of network traffic 305 received by path computation client 135(5) from path computation client 135(6) to web server 125, but along a path that avoids the congested path computation client 135(7) (such as via path computation client 135(3)). This proactively mitigates the fatigue levels because at least a portion of the particular type of network traffic 305 may avoid the areas of greatest fatigue (path computation client 135(7)). Path computation element 130 may use the fatigue map to make the forwarding decisions for routing the remaining portion of the particular type of network traffic 305 around path computation client 135(7).

Thus, the path computation element 130 may act proactively, and does not necessarily need to wait for the fatigue threshold to reach levels that would make the path computation client 135(5) unusable. The path computation element 130 may therefore act as a load balancer prior to acting as a DDoS attack mitigator.

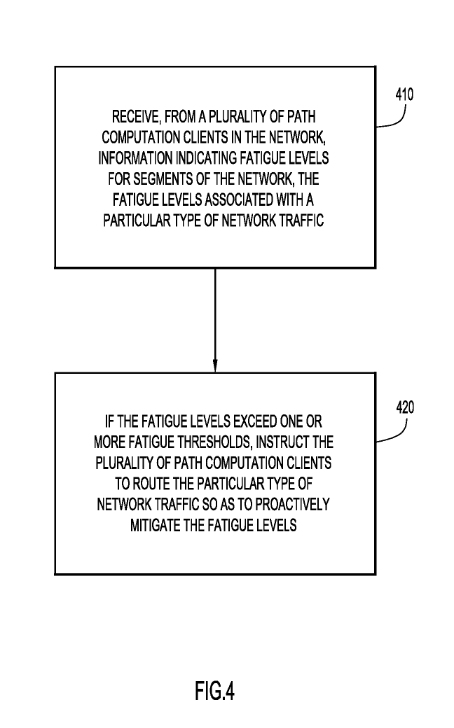

FIG. 4 is a flowchart illustrating, at a high level, a method for carrying out techniques described above in connection with FIG. 3. The method may be performed by a path computation element of a network configured for segment routing, such as path computation element 130. At 410, the path computation element receives, from a plurality of path computation clients in the network, information indicating fatigue levels for segments of the network, the fatigue levels being associated with a particular type of network traffic. At 420, if the fatigue levels exceed one or more fatigue thresholds, the path computation element instructs the plurality of path computation clients to route the particular type of network traffic so as to proactively mitigate the fatigue levels.

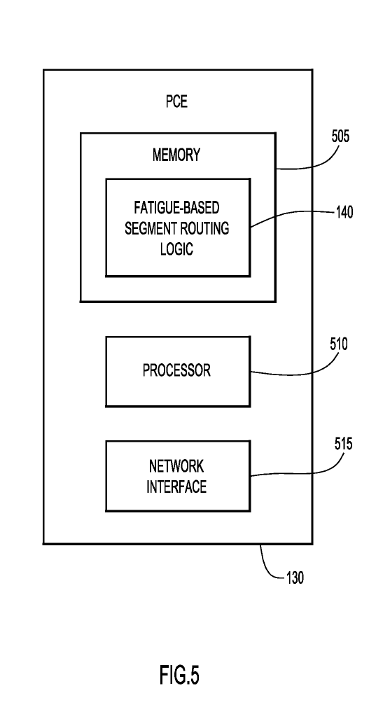

FIG. 5 is a block diagram of path computation element 130 configured to implement the techniques presented herein. In this example, the path computation element 130 includes a memory 505 that stores instructions for fatigue-based segment routing logic 140, one or more processors 510, and a network interface 515. The one or more processors 510 are configured to execute instructions stored in the memory 505 (fatigue-based segment routing logic 140). When executed by the one or more processors 510, the fatigue-based segment routing logic 140 causes the path computation element 130 to perform operations described herein. The network interface 515 is a network interface card or other network interface device that enables network communications on behalf of the path computation element 130 for sending and receiving messages as described above.

The memory 505 may be read only memory (ROM), random access memory (RAM), magnetic disk storage media devices, optical storage media devices, flash memory devices, electrical, optical, or other physical/tangible memory storage devices. Thus, in general, the memory 505 may be one or more tangible (non-transitory) computer readable storage media (e.g., a memory device) encoded with software comprising computer executable instructions and when the software is executed (by the processor 510) it is operable to perform the operations described herein.

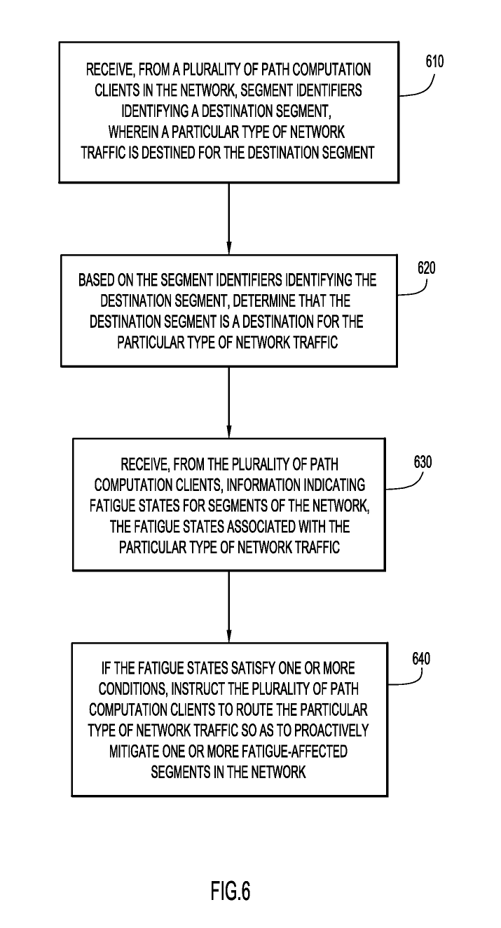

FIG. 6 is a flowchart of a fatigue-based routing method in accordance with examples presented herein. The method may be performed at a path computation element of a network configured for segment routing. At 610, the path computation element receives, from a plurality of path computation clients in the network, segment identifiers identifying a destination segment, wherein a particular type of network traffic is destined for the destination segment. At 620, based on the segment identifiers identifying the destination segment, the path computation element determines that the destination segment is a destination for the particular type of network traffic. At 630, the path computation element receives, from the plurality of path computation clients, information indicating fatigue states (such as levels) for segments of the network, the fatigue states associated with the particular type of network traffic. At 640, if the fatigue states satisfy (such as exceed) one or more conditions (such as fatigue thresholds), the path computation element instructs the plurality of path computation clients to route the particular type of network traffic so as to proactively mitigate one or more fatigue-affected segments in the network.

The techniques described herein may use a fatigue prone segment identifier to proactively identify hosts that might be vulnerable to attacks identified by DDoS pattern detection tools. This proactive identification may occur before the DDoS attack has actually occurred. Congestion points (such as gateway routers) may also receive a fatigue prone segment identifier. As the load on these points increases the associated fatigue index may also increase. The path computation element may progressively re-route traffic around fatigued points (and also around points of the same network with similar vulnerabilities) using segment routing.

As previously described, a path computation element may build a map of fatigue prone points in the network. Using the map, the path computation element may identify the final segments to which the sensitive traffic is directed, and also identify the forwarding routers and segments along that path. The redirection may prioritize load balancing (such as traffic destined for a segment where one host is fatigued), avoiding congestion points (such as by redirecting traversing traffic around the congested segment), and redirecting to scrubbers (for traffic targeting the fatigued host). The redirection may also anticipate congestion of other segments where similar vulnerabilities are identified (but no attack has yet occurred). In one example, the suspect traffic to be directed toward a scrubber from the edge of the network. In another example, when a local router observes sensitive traffic exceeding a target threshold, the router may send a fatigue flag to the upstream router, thereby directing the upstream router to begin redirecting traffic to the local scrubber.

These techniques enable proactive identification of segments and hosts that are vulnerable to DDoS attacks. This identification enables at least three mitigation mechanisms that standard post attack redirection techniques typically cannot implement. First, these techniques enable the prediction of other segments that could become overloaded based on the characteristics of an attack that has not yet been directed to those sensitive segments. Expectation of a sudden load over these segments may be accounted for in the redirection effort that takes place when another host is attacked. For example, if hosts A and B in a given enterprise network both offer service x, and host A is suddenly under attack, redirection may be designed to avoid forwarding traversing traffic to the segment where host B resides, in the anticipation that B will be the next to be attacked.

Second, mitigation may begin before overload. As the fatigue index increases, redirection may take place progressively. This may allow for optimization of the reaction to an attack that ramps up in intensity (instead of a binary threshold action).

Third, the fatigue segment identifier may identify a host, thereby enabling progressive traffic redirection around the weak segment to be applied to traffic directed to that (progressively fatigued) host. For example, if hosts A and B in a given enterprise network offer services x and y, and reside on the same segment, an increased fatigue on host A's service x may prompt the redirection of traffic to host B through another, safer path. This may occur while traffic to host A is progressively load balanced through more paths to host A that do not overlap with the path reserved for traffic to host B, and/or while traffic to host A is selectively sent to a DDoS filter.

In addition, these techniques may be performed on a per-application basis. This may provide improved flexibility over simple routing update or “redirect to scrubber” capability. Moreover, traffic detection/redirection may be enabled based on individual services running on a host. For example, higher priority applications may be routed first, before lower priority applications. The path computation element may also/alternatively re-route traffic on a per-flow basis.

As described herein, a path computation element may interpret data received from path computation clients as indications of fatigue, and may make adjustments to the network in response to an ongoing or anticipated DDoS attack. The path computation element may thus proactively react to a DDoS attack. The path computation element may use segment routing mechanisms to prevent the DDoS attack. These segment routing mechanisms may also provide the path computation element with a topological view of the network. Instead of simply using segment routing mechanisms for conventional applications (e.g., latency), the path computation element may use segment routing mechanisms to perform fatigue-based analysis and routing for a network. The path computation element may create a label path and impose that label path onto path computation clients in order to optimize (load balance over multiple links or on a per-flow basis) to reduce/minimize fatigue on the path computation clients.

In one form, a method is provided. The method comprises: at a path computation element of a network configured for segment routing: receiving, from a plurality of path computation clients in the network, segment identifiers identifying a destination segment, wherein a particular type of network traffic is destined for the destination segment; based on the segment identifiers identifying the destination segment, determining that the destination segment is a destination for the particular type of network traffic; receiving, from the plurality of path computation clients, information indicating fatigue states for segments of the network, the fatigue states associated with the particular type of network traffic; and if the fatigue states satisfy one or more conditions, instructing the plurality of path computation clients to route the particular type of network traffic so as to proactively mitigate one or more fatigue-affected segments in the network.

In another form, an apparatus is provided. The apparatus comprises: a network interface configured send and receive communications in a network configured for segment routing; memory; and one or more processors coupled to the network interface and the memory, wherein the one or more processors are configured to: receive, from a plurality of path computation clients in the network, segment identifiers identifying a destination segment, wherein a particular type of network traffic is destined for the destination segment; based on the segment identifiers identifying the destination segment, determine that the destination segment is a destination for the particular type of network traffic; receive, from the plurality of path computation clients, information indicating fatigue states for segments of the network, the fatigue states associated with the particular type of network traffic; and if the fatigue states satisfy one or more conditions, instruct the plurality of path computation clients to route the particular type of network traffic so as to proactively mitigate one or more fatigue-affected segments in the network.

In another form, one or more non-transitory computer readable storage media are provided. The non-transitory computer readable storage media are encoded with instructions that, when executed by a processor, cause the processor to: receive, from a plurality of path computation clients in the network, segment identifiers identifying a destination segment, wherein a particular type of network traffic is destined for the destination segment; based on the segment identifiers identifying the destination segment, determine that the destination segment is a destination for the particular type of network traffic; receive, from the plurality of path computation clients, information indicating fatigue states for segments of the network, the fatigue states associated with the particular type of network traffic; and if the fatigue states satisfy one or more conditions, instruct the plurality of path computation clients to route the particular type of network traffic so as to proactively mitigate one or more fatigue-affected segments in the network.

The above description is intended by way of example only. Although the techniques are illustrated and described herein as embodied in one or more specific examples, it is nevertheless not intended to be limited to the details shown, since various modifications and structural changes may be made within the scope and range of equivalents of the claims.

What is claimed is:

1. A method comprising:
at a path computation element of a network configured for segment routing:
receiving, from a plurality of path computation clients in the network, segment identifiers identifying a destination segment, wherein a particular type of network traffic is destined for the destination segment;
based on the segment identifiers identifying the destination segment, determining that the destination segment is a destination for the particular type of network traffic;
receiving, from the plurality of path computation clients, information indicating fatigue states for segments of the network, the fatigue states associated with the particular type of network traffic; and
if the fatigue states satisfy one or more conditions, instructing the plurality of path computation clients to route the particular type of network traffic so as to proactively mitigate one or more fatigue-affected segments in the network.

2. The method of claim 1, further comprising:
at the path computation element:
sending, to the plurality of path computation clients, segment identifiers identifying the particular type of network traffic.

3. The method of claim 2, wherein sending the segment identifiers identifying the particular type of network traffic includes sending segment identifiers indicating a destination port of the particular type of network traffic.

4. The method of claim 1, further comprising:
generating a network map of the segments, the network map including the fatigue states, and
wherein instructing the plurality of path computation clients to route the particular type of network traffic includes instructing the plurality of path computation clients to route the particular type of network traffic based on the network map.

5. The method of claim 1, wherein:
at least one path computation client of the plurality of path computation clients is a redistribution element; and
the segment identifier identifying the destination and received from the redistribution element indicates that the at least one path computation client is the redistribution element.

6. The method of claim 1, wherein the fatigue states are fatigue levels, and further comprising, at the path computation element, determining whether the fatigue levels exceed one or more fatigue thresholds.

7. The method of claim 1, further comprising:
at the path computation element:
receiving, from the plurality of path computation clients, information indicating whether the fatigue states satisfy the one or more conditions.

8. The method of claim 1, wherein:
the particular type of network traffic is potentially associated with a denial of service attack; and
instructing the plurality of path computation clients to route the particular type of network traffic includes instructing the plurality of path computation clients to route the particular type of network traffic so as to proactively defend against the denial of service attack.

9. The method of claim 1, wherein the destination segment is outside the network.

10. An apparatus comprising:
a network interface configured to send and receive communications in a network configured for segment routing;
memory; and
one or more processors coupled to the network interface and the memory, wherein the one or more processors are configured to:
receive, from a plurality of path computation clients in the network, segment identifiers identifying a destination segment, wherein a particular type of network traffic is destined for the destination segment;
based on the segment identifiers identifying the destination segment, determine that the destination segment is a destination for the particular type of network traffic;
receive, from the plurality of path computation clients, information indicating fatigue states for segments of the network, the fatigue states associated with the particular type of network traffic; and
if the fatigue states satisfy one or more conditions, instruct the plurality of path computation clients to route the particular type of network traffic so as to proactively mitigate one or more fatigue-affected segments in the network.

11. The apparatus of claim 10, wherein the one or more processors are further configured to:
send, to the plurality of path computation clients, segment identifiers identifying the particular type of network traffic.

12. The apparatus of claim 11, wherein the one or more processors are configured to send the segment identifiers identifying the particular type of network traffic by sending segment identifiers indicating a destination port of the particular type of network traffic.

13. The apparatus of claim 10, wherein the one or more processors are further configured to:
generating a network map of the segments, the network map including the fatigue states, and
wherein the one or more processors are configured to instruct the plurality of path computation clients to route the particular type of network traffic by instructing the plurality of path computation clients to route the particular type of network traffic based on the network map.

14. The apparatus of claim 10, wherein:
at least one path computation client of the plurality of path computation clients is a redistribution element; and
the segment identifier identifying the destination and received from the redistribution element indicates that the at least one path computation client is the redistribution element.

15. The apparatus of claim 10, wherein the fatigue states are fatigue levels, and wherein the one or more processors are further configured to:
determine whether the fatigue levels exceed the one or more fatigue thresholds.

16. The apparatus of claim 10, wherein the one or more processors are further configured to:
receive, from the plurality of path computation clients, information indicating whether the fatigue states satisfy the one or more conditions.

17. One or more non-transitory computer readable storage media encoded with instructions that, when executed by a processor, cause the processor to:
receive, from a plurality of path computation clients in the network, segment identifiers identifying a destination segment, wherein a particular type of network traffic is destined for the destination segment;
based on the segment identifiers identifying the destination segment, determine that the destination segment is a destination for the particular type of network traffic;
receive, from the plurality of path computation clients, information indicating fatigue states for segments of the network, the fatigue states associated with the particular type of network traffic; and
if the fatigue states satisfy one or more conditions, instruct the plurality of path computation clients to route the particular type of network traffic so as to proactively mitigate one or more fatigue-affected segments in the network.

18. The non-transitory computer readable storage media of claim 17, wherein the instructions further cause the processor to:
send, to the plurality of path computation clients, segment identifiers identifying the particular type of network traffic.

19. The non-transitory computer readable storage media of claim 18, wherein the instructions that cause the processor to send the segment identifiers identifying the particular type of network traffic includes instructions that cause the processor to send segment identifiers indicating a destination port of the particular type of network traffic.

20. The non-transitory computer readable storage media of claim 17, wherein the instructions further cause the processor to:
generate a network map of the segments, the network map including the fatigue states, and
wherein the instructions that cause the processor to instruct the plurality of path computation clients to route the particular type of network traffic includes instructions that cause the processor to instruct the plurality of path computation clients to route the particular type of network traffic based on the network map.
